(19) United States
(12) Patent Application Publication
(10) Pub. No.: US 2005/0175521 A1
(43) Pub. Date: Aug. 11, 2005

(54) Method for cleaning harmful materials in semiconductor waste gas

(76) Inventor: Wu-Niang Feng, Taipei Hsien (TW)

Correspondence Address: WU-NIANG FENG, 235 CHUNG-HO BOX 8-24, TAIPEI HSIEN, 235, TW

(21) Appl. No.: 10/773,863

(22) Filed: Feb. 9, 2004

(51) Int. Cl. B01D 53/38

(52) U.S. Cl. 423/210

(57) ABSTRACT

A method for purifying semiconductor waste gas comprises the step of: injecting hot air to a waste gas outlet of a semiconductor gas abatement system so that the hot air blows into semiconductor waste gas exhausted from the waste gas outlet for catalyzing and decomposing harmful materials in the semiconductor waste gas. The hot air generates from a hot air generator and the hot air generator is installed in a head section of the semiconductor gas abatement system or directly on or at the outside of the semiconductor gas abatement system. Furthermore, the hot air generator is connected to a hot air supply tube and the hot air is guided to the waste gas outlet in the tank. The hot air is generated from a hot air generator. Thereby, the harmful materials in the semiconductor waste gas can be cleaned completely.

### FIELD OF THE INVENTION

The present invention relates to waste gas processing, and particular to a method for purifying semiconductor waste gas, wherein the high temperature hot air is guided into a waste gas outlet of a semiconductor gas abatement system for catalyzing harmful materials in the semiconductor waste gas.

### BACKGROUND OF THE INVENTION

As knows by people, in the manufacturing process of semiconductors, harmful poisonous semiconductor waste gas will be generated. To avoid pollution of the harmful materials, they must be cleaned before exhausting to outer environment.

To process semiconductor waste gas, a semiconductor gas abatement system is used. The gas abatement system provides a reactive chamber for providing high temperature heat source to decompose or catalyze harmful materials in the semiconductor waste gas. A spraying device in the semiconductor gas abatement system will resolve water solvable harmful materials, such as fluoride, or chlorine carbide, and other powders, into water and then cools so that semiconductor waste gas is converted into harmless materials for exhaustion,

The ways for providing high temperature heat source in the semiconductor gas abatement systems are that:

1. A set of thermal type (heater element) is installed on a wall of the semiconductor gas abatement system. Heat is transferred to the wall of the reactive chamber by heat convection as high temperature heat source. Then the heat is radiated to the semiconductor waste gas in the reactive chamber for decomposing the harmful materials.

Although above mentioned way has the advantage of decomposing and catalyzing semiconductor waste gas in the reactive chamber, since heat is concentrated in or near the wall of the reactive chamber, the distribution of heat in the reactive chamber is not uniform. Thereby, the decomposing and catalyzing of the harmful materials in the reactive chamber are also not uniformly so that the efficiency of the semiconductor gas abatement system is reduced.

Moreover, after the semiconductor waste gas is guided into the reactive chamber, it will disperse into the liner of reactive chamber. If the efficiency for decomposition and catalysis is not uniformly, the semiconductor waste gas in the reactive chamber cannot be reacted completely.

2. An opening is formed at a waste gas outlet of the reactive chamber and an igniter is provided for supplying combusting gas. The gas is combusted by the igniter as a high temperature heat source. Flame serves to catalyze and decompose the semiconductor waste gas in the reactive chamber so as to resolve the problem of incomplete cleanliness of the semiconductor waste gas.

However, above way is dangerous and needs a high cost and thus it is uneconomic.

### SUMMARY OF THE INVENTION

Accordingly, the primary object of the present invention is to provide a method for purifying semiconductor waste gas, wherein hot air is used instead of fire source so that the defects of incomplete cleaning and high cost are improved.

To achieve above object, the present invention provides a method for purifying semiconductor waste gas which comprises the steps of: injecting hot air to a waste gas outlet of a semiconductor gas abatement system so that the hot air blows into semiconductor waste gas exhausted from the waste gas outlet for catalyzing and decomposing harmful materials in the semiconductor waste gas. The hot air is generated from a hot air generator and the hot air generator is installed in a head section of the semiconductor gas abatement system or directly on or at the outside of the semiconductor gas abatement system. Furthermore, the hot air generator is connected to a hot air supply tube and the hot air is guided to the waste gas outlet in the tank. The hot air generates from a hot air generator.

Advantages of the present invention is that the hot air is guided to the waste gas outlet of the semiconductor gas abatement system so as to decompose and catalyze the harmful materials in the semiconductor waste gas for improving the cleaning efficiency. Thereby, the defect of incomplete cleaning due to the non-uniform distribution in the reactive chamber of the semiconductor gas abatement system is overcome. Moreover, in the present invention, air is used as high temperature heat source, and thus it is unnecessary to buy other equipment. The cost is low and no problem of gas draining or explosion. Thereby, the present invention provides a high safety protection to the users.

The various objects and advantages of the present invention will be more readily understood from the following detailed description when read in conjunction with the appended drawing.

### BRIEF DESCRIPTION OF THE DRAWINGS

FIG. 1 is a structural schematic view of the first embodiment about the semiconductor gas abatement system used in the present invention.

FIG. 2 is a structural schematic view of the second embodiment about the semiconductor gas abatement system used in the present invention.

FIG. 3 is a structural schematic view of the third embodiment about the semiconductor gas abatement system used in the present invention.

FIG. 4 is a structural schematic view of the fourth embodiment about the semiconductor gas abatement system used in the present invention.

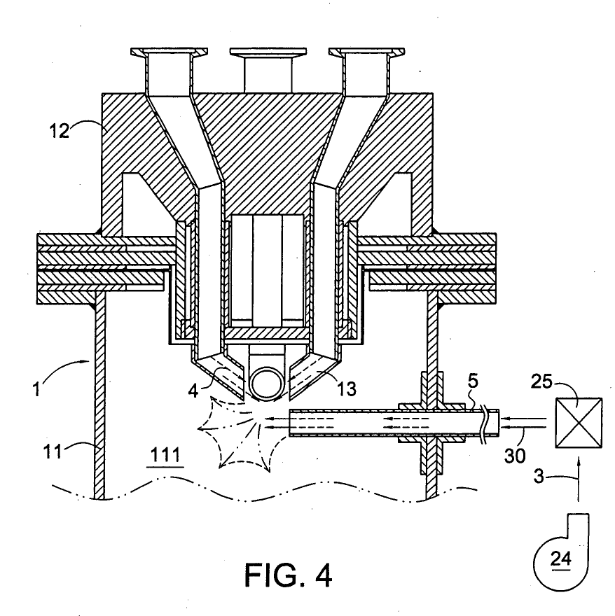

### PREFERRED EMBODIMENT OF THE PRESENT INVENTION

### First Embodiment

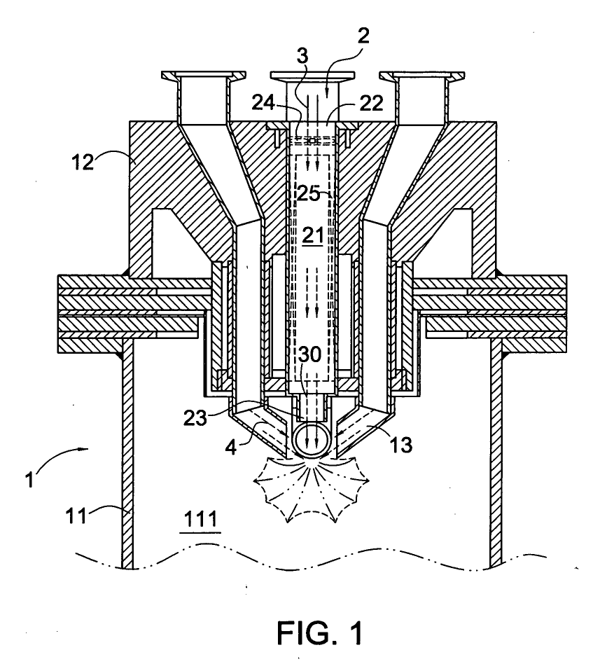

With reference to FIG. 1, a semiconductor gas abatement system 1 used in the method of the present invention is illustrated. The present invention includes a semiconductor gas abatement system 1 having a tank body 11 and a head section 12 and a hot air generator 2.

The tank body 11 has a reactive chamber 111.

The head section 12 is installed at one end of the reactive chamber 111 and the head section 12 has at least one waste gas outlet 13.

The hot air generator 2 is installed on the head section 12. The hot air generator 2 has a heating chamber 21. One end of the heating chamber 21 has a wind inlet 22. The wind inlet 22 is installed with a fan 24. A heater 25 is installed in the heating chamber 21. Another end of the heating chamber 21 has a wind outlet 23. The wind outlet 23 is positioned corresponding to the waste gas outlet 13.

In the method of the present invention, one end of the waste gas outlet 13 of the semiconductor gas abatement system 1 blows hot air 30 for cleaning harmful materials in the waste gas 4 so as to improve the efficiency for cleaning the waste gas 4.

When it is desired to clean the semiconductor waste gas 4, the fan 24 of the hot air generator 2 is used to absorb external air 3 into the heating chamber 21. The heater 25 in the heating chamber 21 will heat the air 3 in the short time period so as to generate high temperature hot air 30. Then the hot air 30 is blown to one end of the waste gas outlet 13 from the wind outlet 23 by force.

When the semiconductor waste gas 4 is guided into the reactive chamber 111 from the waste gas outlet 13, it will mix with the hot air 30 before the waste gas outlet 13 so that harmful materials in the waste gas 4 will be heated for decomposition or be catalysis.

Before dispersing the semiconductor waste gas 4, the harmful material in the semiconductor waste gas 4 guided into the reactive chamber 111 is cleaned by the injecting hot air 30. Therefore, the harmful materials in the semiconductor waste gas 4 do not disperse to other portion of the reactive chamber 111. Thereby, the deficiency due to the improper disperse of the harmful materials of the semiconductor waste gas 4 is improved.

Moreover, since the hot air 30 is formed by sucking and heating external hot air 30 by the hot air generator 2, the resource and temperature of the hot air 30 are controlled and thus the cleaning efficiency of the present invention can be well and steadily controlled. Furthermore, in the present invention, air 3 is used as high temperature heat source, and thus it is unnecessary to buy other equipment. The cost is low and no problem of gas draining or explosion. Thereby, the present invention provide a high safety protection to the users.

The function of the hot air generator 2 used in the present invention is mainly used to generate hot air 30 for catalyze or decomposing harmful materials. Thereby, hot air 30 can steadily inject to one end of the waste gas outlet 13.

### Second Embodiment

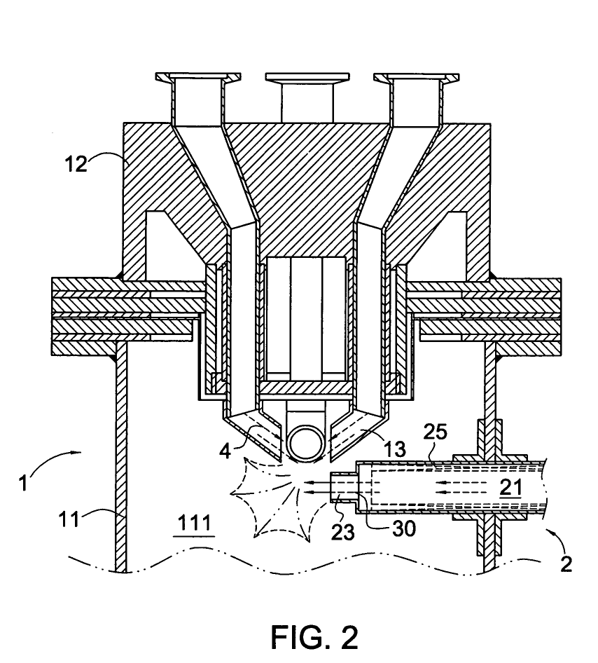

With reference to FIG. 2, a structural schematic view about the semiconductor gas abatement system 1 used in the second embodiment of the method for purifying semiconductor waste gas of the present invention is illustrated. The structure is like that in the first embodiment. The difference there between will be described herein.

The hot air generator 2 is installed on the tank body 11 at a position causes that the hot air 30 can be steadily injected to one end of the waste gas outlet 13.

### Third Embodiment

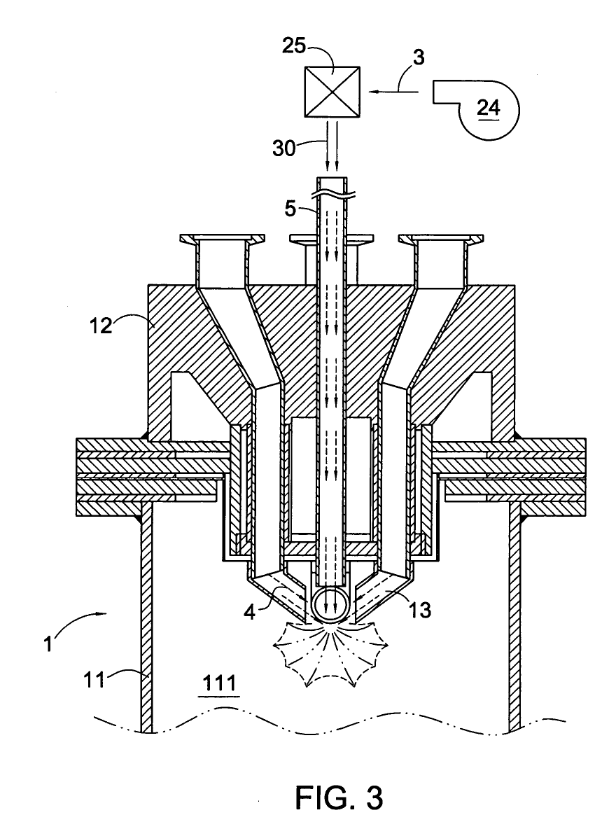

With reference to FIG. 3, a structural schematic view about the semiconductor gas abatement system 1 used in the second embodiment of the method for purifying semiconductor waste gas of the present invention is illustrated. The structure is like that in the first embodiment. The difference there between will be described herein.

The hot air generator 2 is installed outside the tank body 11 at a position which causes hot air 30 to be steadily injected to one end of the waste gas outlet 13. Then a hot air supply tube 5 serves to guide hot air 30 from the head section 12 to the tank body 11.

### Fourth Embodiment

With reference to FIG. 3, a structural schematic view about the semiconductor gas abatement system 1 used in the second embodiment of the method for purifying semiconductor waste gas of the present invention is illustrated. The structure is like that in the first embodiment. The difference there between will be described herein.

The hot air generator 2 is installed outside the tank body 11 at a position which cause the hot air 30 to be steadily injected to one end of the waste gas outlet 13. Then a hot air tube 5 serves to guide hot air 30 to the tank body 11.

The hot air generator 2 used in the present invention is known in the prior art and it is not required to be installed only on the head section 12.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for purifying semiconductor waste gas comprising the step of:
injecting hot air to a waste gas outlet of a semiconductor gas abatement system so that the hot air blows into semiconductor waste gas exhausted from the waste gas outlet for catalyzing and decomposing harmful materials in the semiconductor waste gas.

2. The method for purifying semiconductor waste gas as claimed in claim 1, wherein the hot air generates from a hot air generator.

3. The method for purifying semiconductor waste gas as claimed in claim 2, wherein the hot air generator is installed in a head section of the semiconductor gas abatement system.

4. The method for purifying semiconductor waste gas as claimed in claim 2, wherein the hot air generator is installed on the semiconductor gas abatement system.

5. The method for purifying semiconductor waste gas as claimed in claim 2, wherein the hot air generator is installed outside of the semiconductor gas abatement system.

6. The method for purifying semiconductor waste gas as claimed in claim 5, wherein the hot air generator is connected to a hot air supply tube and the hot air is guided to the waste gas outlet in the semiconductor gas abatement system.

7. The method for purifying semiconductor waste gas as claimed in claim 1 6, wherein the hot air supply tube is installed on the head section of the semiconductor gas abatement system.

8. The method for purifying semiconductor waste gas as claimed in claim 6, wherein the hot air tube is installed in the semiconductor gas abatement system.
